(19) United States
(12) Patent Application Publication
(10) Pub. No.: US 2002/0083637 A1
(43) Pub. Date: Jul. 4, 2002

(54) Anti-trash buzz blade

(76) Inventors: Chu Shoh Lee, Hyogo (JP); Satoshi Yoshida, Hyogo (JP); Chyi Chen Hong, City of Industry, CA (US); Hideki Maeda, Osaka (JP)

Correspondence Address: Raymond Yat Chan, 1050 Oakdale Lane, Arcadia, CA, 91006, US

(21) Appl. No.: 09/751,337

(22) Filed: Dec. 29, 2000

(51) Int. Cl. A01K 85/00

(52) U.S. Cl. 43/42.19

(57) ABSTRACT

An anti-trash buzz blade includes a blade body having a central axle slot wherein an axle arm of a fishing lure is rotatably inserted into the axle slot of the blade body, a locking member, which is affixed to a rear end of the axle arm, for rotatably locking the blade body on the axle arm, and a protective cap rearwardly extended from the blade body wherein the protective cap is arranged in such a manner that when the fishing lure is pull and drive the blade body to rotate, the locking member is received in the protective cap. Therefore, the protective cap is capable of preventing trashes from being caught by the locking member while the anti-trash buzz blade is incorporating with the fishing lure.

### BACKGROUND OF THE PRESENT INVENTION

1. Field of Invention

The present invention relates to fishing lures, and more particularly to an anti-trash buzz blade adapted for employing with a fishing lure, which can prevent the buzz blade from being wound by trashes such as seaweed while fishing.

2. Description of Related Arts

Sport fishing is one of the popular outdoor sports since people at all ages are able to participate in the sport fishing. In the sports fishing, a fishing lure is generally used for attracting fishes so that the people can easily catch the fishes.

Referring to FIG. 1, U.S. Pat. No. 4,201,008, owned by Sparkman, discloses a surface type fishing lure for fishing in a pool, or a brook. The conventional fishing lure comprises a fishhook 1, a supporting frame 2 extended from the fishhook 1, and a blade 3 rotatably connected to the supporting frame 2 for attracting the fish's attention, wherein when the fishing lure is pull by a fishing wire 4, the blade 3 is freely rotated on the supporting frame 2 by means of the stream of water so as to generate sound to get the fish's attention.

In order to rotatably mount the blade 3 on the supporting frame 2, the blade 3 has a center circular slot 3A wherein the supporting frame 2 having a shaft 2A is rotatably inserted into the circular slot 3A of the blade 3. A rivet 5 is mounted on a rear end of the shaft 2A for locking up the blade 3 on the shaft 2A of the supporting frame 2.

However, there are drawbacks of the conventional fishing lure. When the fishing lure is pulled, trashes such as seaweed may be grasped by the rivet 5 such that the seaweed may wound around the shaft 2A of the supporting frame 2, which will block the rotation of the blade 3. So, the fisher may merely remove the seaweed by hand. Since the fishhook 1, which is positioned close to the rivet 5, is sharp and fine, the fisher's hand may easy to get hurt while removing the trash on the shaft 2A.

Thus, the sound is generated by the friction between the shaft 2A and the rotating blade 3. However, the shape of the circular slot 3A of the blade 3 may not good for frictionally contacting with the shaft 2 in order to generate sound to attract the fish's attention.

### SUMMARY OF THE PRESENT INVENTION

A main object of the present invention is to provide an anti-trash buzz blade adapted for employing with a fishing lure, wherein the buzz blade is adapted for preventing trashes such as seaweed being wound around the buzz blade, which may block the rotation of the buzz blade.

Another object of the present invention is to provide an anti-trash buzz blade which is capable of generating a louder sound than a conventional one so as to attract the fish's attention efficiently.

Another object of the present invention is to provide an anti-trash buzz blade, which does not require to alter the original structural design of the fishing lure, so as to minimize the manufacturing cost for incorporating the buzz blade with every conventional fishing lure having a shaft.

Accordingly, in order to accomplish the above objects, the present invention provide an anti-trash buzz blade for fishing lure which comprises a fishhook and a supporting frame, having an axle arm, extended from the fishhook, wherein the anti-trash buzz blade, rotatably mounted on the axle arm, comprises:

a blade body having a central axle slot wherein the axle arm of the supporting frame is rotatably inserted into the axle slot of the blade body;

a locking member, which is affixed to a rear end of the axle arm, for locking the blade body on the axle arm of the supporting frame; and

a protective cap rearwardly extended from the blade body wherein the protective cap is arranged in such a manner that when the fishing lure is pull and drive the blade body to rotate, the locking member is received in the protective cap.

### BRIEF DESCRIPTION OF THE DRAWING

FIG. 1 is a perspective view of a conventional fishing lure.

FIG. 2 is a perspective view of an anti-trash buzz blade for fishing lure according to a first preferred embodiment of the present invention.

FIG. 3 is a partially sectional view of the anti-trash buzz blade according to the above first preferred embodiment of the present invention.

FIG. 4 illustrates an alternative mode of a locking member of the anti-trash buzz blade according to the above first preferred embodiment of the present invention.

FIG. 5 is an exploded perspective view of the anti-trash buzz blade according the above first preferred embodiment of the present invention.

FIG. 6 illustrates a first alternative mode of the anti-trash buzz blade according to the above first preferred embodiment of the present invention.

FIG. 7 illustrates a second alternative mode of the anti-trash buzz blade according to the above first preferred embodiment of the present invention.

FIG. 8 is a perspective view of an anti-trash buzz blade according to a second preferred embodiment of the present invention.

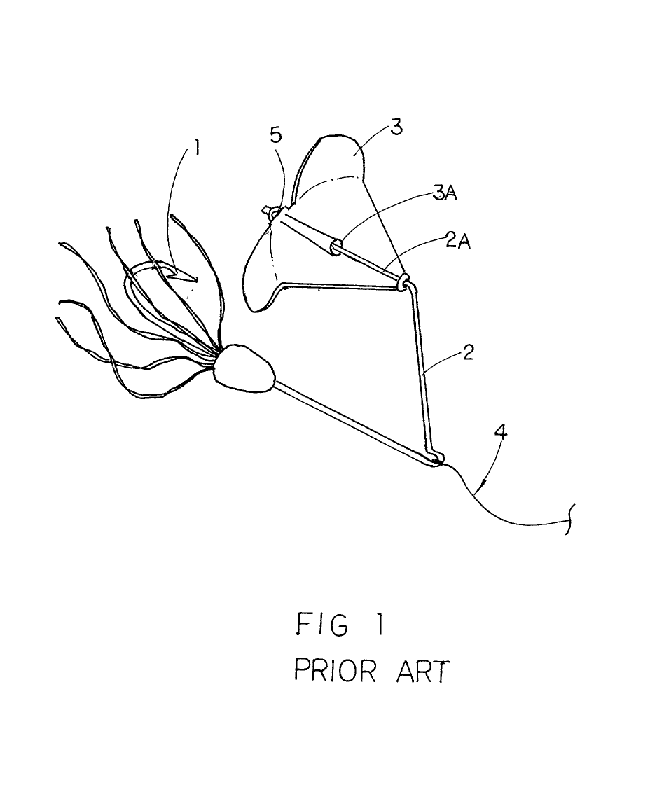

### DETAILED DESCRIPTION OF THE PREFERRED EMBODIMENT

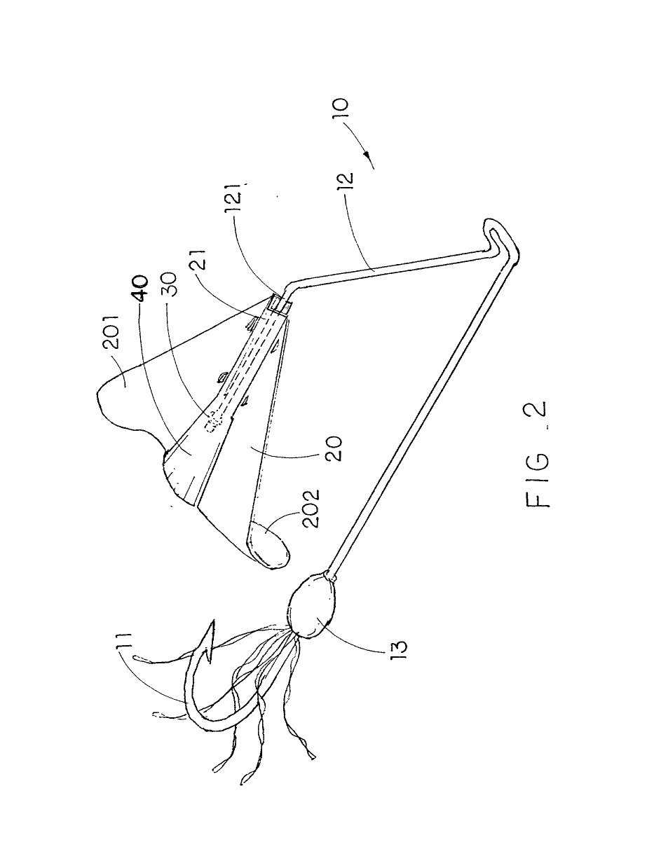

Referring to FIG. 2 of the drawings, an anti-trash buzz blade according to a preferred embodiment of the present invention is illustrated, wherein the anti-trash buzz blade is adapted for incorporating with a fishing lure 10. The fishing lure 10, such as a standard fishing lure, comprises a fishhook 11, a supporting frame 12 having an axle arm 121 extended from the fishhook 11, and a sinker 13 for providing a predetermined weight for the fishing lure 10, wherein the anti-trash buzz blade of the present invention is adapted for rotatably mounting on the axle arm 121 of the supporting frame 12.

According to the preferred embodiment, the anti-trash buzz blade comprises a blade body 20 having a central axle slot 21 wherein the axle arm 121 of the supporting frame 12 is rotatably inserted into the axle slot 21 of the blade body 20, a locking member 30, which is affixed to a rear end of the axle arm 121, for locking the blade body 20 on the axle arm 121 of the supporting frame 12, and a protective cap 40 rearwardly extended from the blade body 20 wherein the protective cap 40 is arranged in such a manner that when the fishing lure 10 is pull and drive the blade body 20 to rotate, the locking member 30 is received in the protective cap 40.

The blade body 20 further comprises two rear spinning wings 201, 202 opposedly bent at a predetermined angle with respect to the blade body 20. The spinning wings 201, 202 are arranged to drive the blade body 20 to rotate on the axle arm 121 of the supporting frame 12 while the blade body 20 is moved forward. In other words, when the fishing lure 10 is pull forwardly, a steam of water flows along the blade body 20 and hits the spinning wings 201, 202 to drive blade body to rotate. Accordingly, the blade body 20 is made of durable material such as metal or plastic, which is capable of generating sound when the blade body 20 is frictionally collided with the axle arm 121 of the supporting frame 12 in a rotatably movable manner.

The axle slot 21 of the blade body 20 is formed in a non-circular shape, which is a diamond shape as shown in FIG. 2, wherein the axle slot 21 is longitudinally extended along the entire blade body 20, which is adapted for increasing a frictional area between the axle slot 21 and the axle arm 121 of the supporting frame 12, so as to enhance the “buzz” sound generated by the friction therebetween while the blade body 20 is rotating on the axle arm 21. Since the buzz sound is capable of attracting the fish's attention, the louder of the buzz sound is generated, the better attraction of the fish's attention is achieved. So, the particular non-circular shape of the axle slot 21 can generate louder sound to enhance the attraction of the fish.

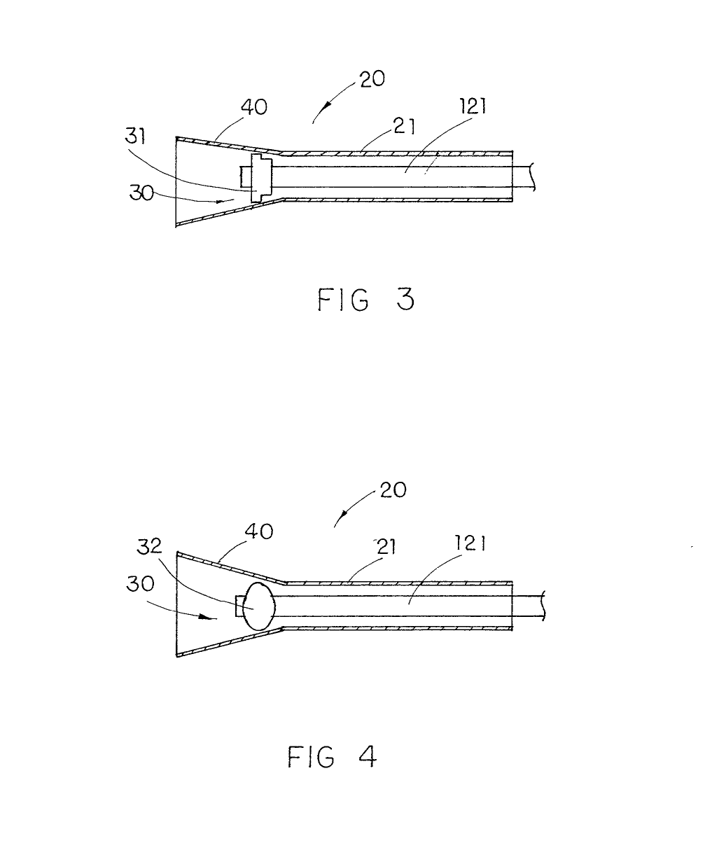

The protective cap 40 having a cone shape is integrally extended from the blade body 20 wherein the protective cap 40 is adapted for covering the locking member 30, as shown in FIGS. 3 and 4. As it is mentioned in the background, the trash in the stream such as seaweed is easily caught by the locking member 40 while the fishing lure 10 is moving in the stream. So, when the locking member 30 is received in the protective cap 40, the stream of water and the trashes will flow along the protective cap 40 such that the trashes will not be caught by the locking member 30 by chance.

Thus, an unexpected result of the protective cap 40 is achieved that when the protective cap 40 rotatably covers the locking member 30, a sound is generated by the frictional collision between the protective cap 40 and the locking member 30. So, the sound can be loudly generated by the friction not only between the axle slot 21 and the axle arm 121 but only between the protective cap 40 and the locking member 30, so as to further enhance the attraction of the fish's attention.

Accordingly, the locking member 30 comprises a rivet 31 securely affixed to the rear end of the axle arm 121 of the supporting frame 12 so as to rotatably lock up the blade body 20 on the axle arm 121, as shown FIG. 3. Alternatively, the locking member 30 comprises a bead 32 affixed to the rear end of the axle arm 121 of the supporting arm 12 so as to achieve the locking function as mentioned above, as shown in FIG. 4.

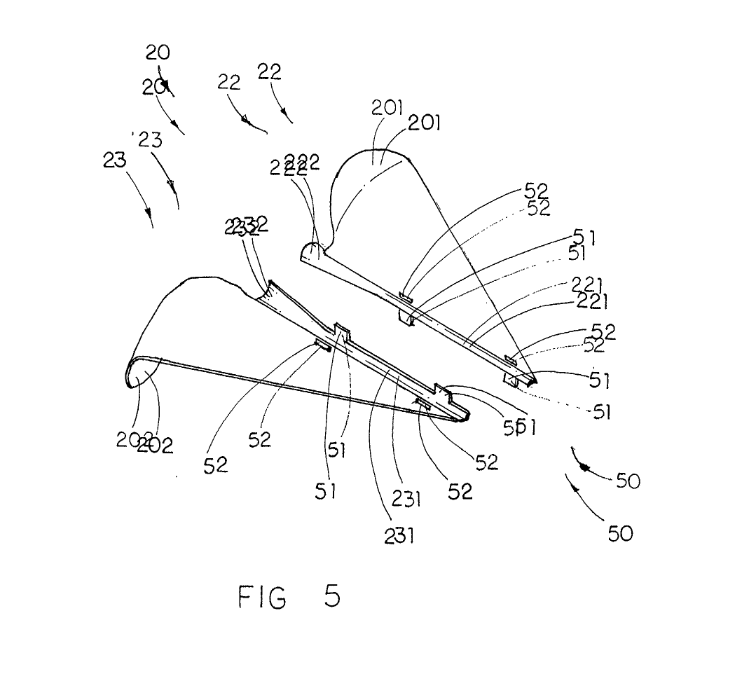

Referring to FIG. 5, the blade body 20 comprises a pair of blade members 22, 23 overlappedly connected together to form the blade body 20, wherein each of the blade member 22, 23 comprises the spinning wing 201, 202 rearwardly extended therefrom in a bending manner. Each blade member 22, 23 has a slot flap 221, 231 integrally extended from an inner edge of the blade member 22, 23 respectively wherein the two slot flaps 221, 231 of the two blade members 22, 23 are respectively connected together to form the axle slot 21 when the two blade members 22, 23 are overlappedly connected each other.

Thus, each slot flap 221, 231 of the blade member 22, 23 has a gradually enlarged rear cap portion 222, 232 wherein the cone shaped protective cap 40 is formed by the two rear cap portions 222, 232 of the slot flaps 221, 241 when the two blade members 22, 23 are connected together.

The anti-trash buzz blade further comprises an attaching means 50 for attaching the blade members 22, 23 together wherein the attaching means 50 has at least a mounting protrusion 51 integrally extended from the slot flap 221, 231 of the blade member 22, 23 and at least a corresponding mounting slot 52 form on the blade member 22, 23 adjacent to the slot flap 221, 231 thereof in such a manner that the mounting protrusion 51 on the blade member 22, 23 is securely inserted into the mounting slot 52 on another blade member 23, 22 so as to substantially connect the two blade members 22, 23 together to form the blade body 20.

It is worth to mention that the two blade members 22, 23 are identical the same such that only one mold is necessary to produce the blade member 22, 23 in the manufacturing process. When two blade members 22, 23 are manufactured by the mold, simply flip one of the blade members 22, 23 up side down and then connect the blade members 22, 23 together. So, the manufacturing cost of the present invention can be minimized.

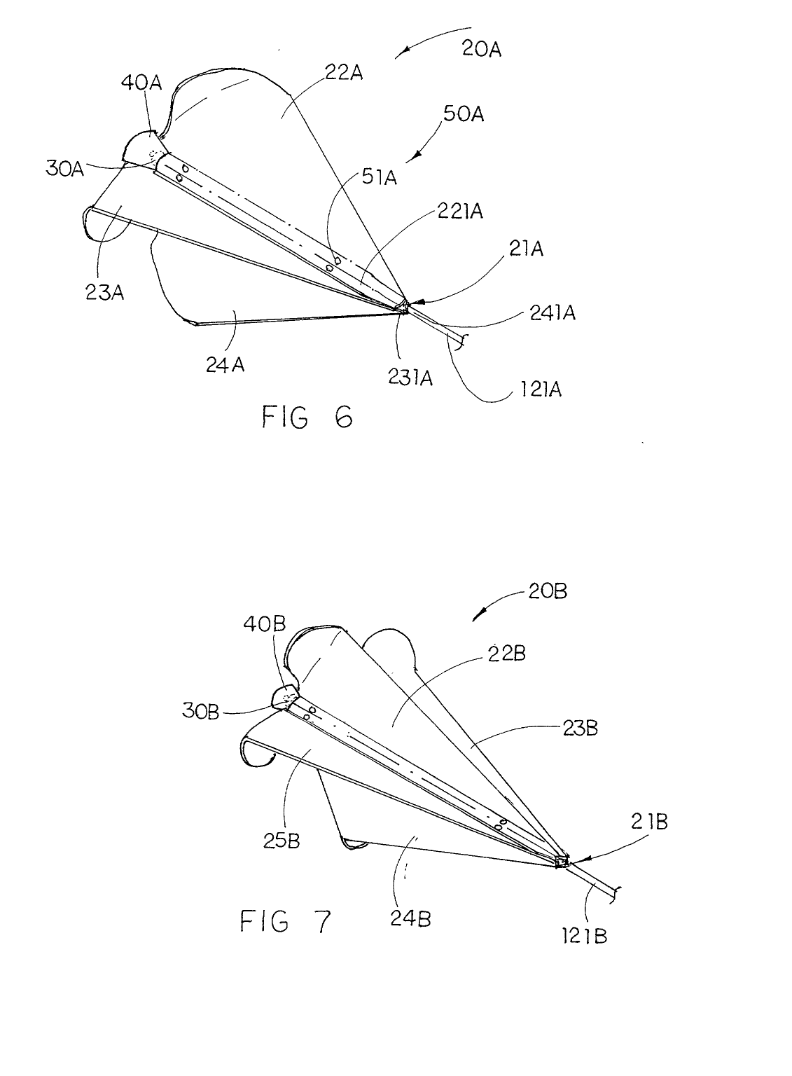

FIGS. 6 and 7 illustrate a first and second alternative modes of the anti-trash buzz blade according to the preferred embodiment of the present invention, wherein more than two blade members 22, 23 are overlappedly connected together to form the blade body 20. Thus, the protective cap 40 is provided at a rear end of the blade body 20 for covering the locking member 30 wherein sounds are adapted for being generated not only between the protective cap 40 and the locking member 30 but also between the protective cap 40 and the blade body 20.

As shown in FIG. 6, the blade body 20A comprises three identical blade members 22A, 23A, 24A, each having a slot flap 221A, 23 1A, 241A integrally extended from the inner edge of the respective blade member 22A, 23A, 24A wherein the slot flaps 221A, 231A, 241A of the three blade members 22A, 23A, 24A are overlappedly attached on another respective blade members 23A, 24A, 22A to form the axle slot 21A having a triangular cross section.

The protective cap 40A having a semi-circular shape is rotatably mounted on the rear end of the axle arm 121A such that the locking member 30A is received in the protective cap 40A. When the blade body 20A is driven to be rotated, a frictional collision between the blade body 20A and the protective cap 40A will generate sound which will also enhance the attraction of the fish's attention.

The attaching means 50A comprises a plurality of rivets 51 A securely attaching the slot flap 221A, 231A, 231A to the respective blade member 22A, 23A, 24A so as to substantially connect the three blade members 22A, 23A, 24A together.

As shown in FIG. 7, the blade body 20B comprises four identical blade members 22B, 23B, 24B, 25B, overlappedly connected each other to form the axle slot 21B which has a diamond shape cross section. The protective cap 40B having a semi-circular shape is rotatably mounted on the rear end of the axle arm 121B such that the locking member 30B is received in the protective cap 40B. The connection of the blade members 22B, 23B, 24B, 25B are the same as mentioned above wherein the alternative mode of the blade body 20B purposely indicates that the blade body of the present invention may be constructed by various numbers of the blade member so that the present invention is not limited thereto.

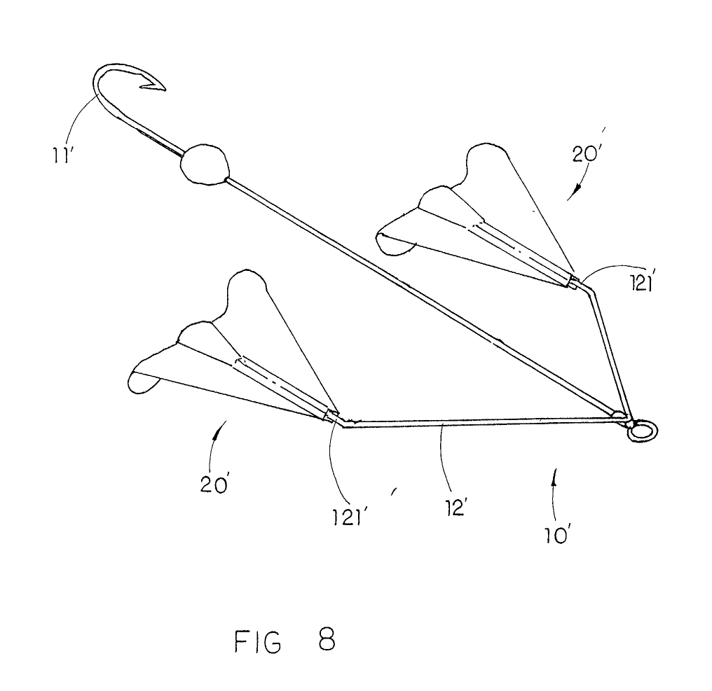

Referring to FIG. 8, an anti-trash buzz blade according to the second preferred embodiment of the present invention is illustrated, wherein the second preferred embodiment mainly illustrates how the anti-trash buzz blade incorporating with the fishing lure.

As shown in FIG. 8, the fishing lure 10′ comprises two fishhooks 11′, a Ushaped supporting frame 12′, having two axle arms 121′, extended from the fishhooks 11′, and two sinkers 13′ affixed to the supporting frame 12′ for providing a predetermined weight to the fishing lure 10′, wherein two blade bodies 20′ of the two anti-trash buzz blades of the present invention are rotatably mounted on the two axle arms 121′ of the supporting frame 12′ respectively.

While the foregoing description and figures describe the preferred embodiments and their alternative modes of the present invention, it should be appreciated that certain obvious modifications, variations, and substitutions such as the shape of the blade body and the number of blade members may be made without departing from the spirit and scope of the present invention.

What is claimed is:

1. An anti-trash buzz blade for a fishing lure comprising at least a fishhook and a supporting frame having an axle arm extended from said fishhook, wherein said anti-trash buzz blade, which is adapted for rotatably mounting on said axle arm of said supporting frame, comprises:
a blade body having a central axle slot for enabling said axle arm of said supporting frame to rotatably insert therein;
a locking member for affixing to a rear end of said axle arm so as to lock said blade body rotatably on said axle arm of said supporting frame; and
a protective cap rearwardly extended from said blade body to cover said locking member in such a manner that when said fishing lure is pull and drive said blade body to rotate, said locking member is received in said protective cap.

2. An anti-trash buzz blade, as recited in claim 1, wherein said axle slot has a non-circular cross-sectional shaped and is longitudinally extended along said blade body, so as to increase a frictional collision between said central axle slot and said axle arm of said supporting frame.

3. An anti-trash buzz blade, as recited in claim 1, wherein said blade body comprises at least two blade members overlappedly connected together to form said blade body, wherein each of said blade member has a spinning wing rearwardly extended therefrom in a bending manner, a slot flap integrally extended from an inner edge of said blade member in such a manner that said two slot flaps are connected overlappedly together to form said central axle slot when said blade members are connected with each other.

4. An anti-trash buzz blade, as recited in claim 2, wherein said blade body comprises at least two blade members overlappedly connected together to form said blade body, wherein each of said blade member has a spinning wing rearwardly extended therefrom in a bending manner, a slot flap integrally extended from an inner edge of said blade member in such a manner that said two slot flaps are connected overlappedly together to form said central axle slot when said blade members are connected with each other.

5. An anti-trash buzz blade, as recited in claim 3, wherein each of said slot flaps of said blade member has a gradually enlarged rear cap portion, wherein said two rear cap portions of said slot flaps are connected side by side to form said protective cap in form of a cone shaped body when said blade members are connected together.

6. An anti-trash buzz blade, as recited in claim 4, wherein each of said slot flaps of said blade member has a gradually enlarged rear cap portion, wherein said two rear cap portions of said slot flaps are connected side by side to form said protective cap in form of a cone shaped body when said blade members are connected together.

7. An anti-trash buzz blade, as recited in claim 3, further comprising an attaching means for attaching said blade members together, said attaching means comprising at least a mounting protrusion integrally extended from said slot flap of each of said blade members and at least a corresponding mounting slot form on each of said blade members adjacent to said slot flap thereof, wherein said mounting protrusion of each of said two blade members is securely inserted into said respective mounting slot of said another blade member so as to substantially connect said two blade members together to form said blade body.

8. An anti-trash buzz blade, as recited in claim 4, further comprising an attaching means for attaching said blade members together, said attaching means comprising at least a mounting protrusion integrally extended from said slot flap of each of said blade members and at least a corresponding mounting slot form on each of said blade members adjacent to said slot flap thereof, wherein said mounting protrusion of each of said two blade members is securely inserted into said respective mounting slot of said another blade member so as to substantially connect said two blade members together to form said blade body.

9. An anti-trash buzz blade, as recited in claim 5, further comprising an attaching means for attaching said blade members together, said attaching means comprising at least a mounting protrusion integrally extended from said slot flap of each of said blade members and at least a corresponding mounting slot form on each of said blade members adjacent to said slot flap thereof, wherein said mounting protrusion of each of said two blade members is securely inserted into said respective mounting slot of said another blade member so as to substantially connect said two blade members together to form said blade body.

10. An anti-trash buzz blade, as recited in claim 6, further comprising an attaching means for attaching said blade members together, said attaching means comprising at least a mounting protrusion integrally extended from said slot flap of each of said blade members and at least a corresponding mounting slot form on each of said blade members adjacent to said slot flap thereof, wherein said mounting protrusion of each of said two blade members is securely inserted into said respective mounting slot of said another blade member so as to substantially connect said two blade members together to form said blade body.

11. An anti-trash buzz blade, as recited in 6, wherein said locking member comprises a rivet securely affixed to said rear end of said axle arm for rotatably locking said blade body on said axle arm of said supporting frame.

12. An anti-trash buzz blade, as recited in 10, wherein said locking member comprises a rivet securely affixed to said rear end of said axle arm for rotatably locking said blade body on said axle arm of said supporting frame.

13. An anti-trash buzz blade, as recited in 6, wherein said locking member comprises a bead securely affixed to said rear end of said axle arm for rotatably locking said blade body on said axle arm of said supporting frame.

14. An anti-trash buzz blade, as recited in 10, wherein said locking member comprises a bead securely affixed to said rear end of said axle arm for rotatably locking said blade body on said axle arm of said supporting frame.

15. An anti-trash buzz blade, as recited in claim 3, wherein said protective cap is rotatably mounted on said rear end of said axle arm for receiving said locking member therein, wherein a sound is adapted for being generated by a frictional collision between said protective cap and said blade body while said blade body is driven to be rotated.

16. An anti-trash buzz blade, as recited in claim 4, wherein said protective cap is rotatably mounted on said rear end of said axle arm for receiving said locking member therein, wherein a sound is adapted for being generated by a frictional collision between said protective cap and said blade body while said blade body is driven to be rotated.

17. An anti-trash buzz blade, as recited in claim 15, further comprising an attaching for overlappedly connecting said blade members together wherein said attaching means comprises at least a rivet securely attaching said slot flap to said respective blade member so as to substantially connect said blade members together.

18. An anti-trash buzz blade, as recited in claim 16, further comprising an attaching means for overlappedly connecting said blade members together wherein said attaching means comprises at least a rivet securely attaching said slot flap to said respective blade member so as to substantially connect said blade members together.

19. An anti-trash buzz blade, as recited in 18, wherein said locking member comprises a rivet securely affixed to said rear end of said axle arm for rotatably locking said blade body on said axle arm of said supporting frame.

20. An anti-trash buzz blade, as recited in 18, wherein said locking member comprises a bead securely affixed to said rear end of said axle arm for rotatably locking said blade body on said axle arm of said supporting frame.
